(19) United States
(12) Patent Application Publication
(10) Pub. No.: US 2003/0046145 A1
(43) Pub. Date: Mar. 6, 2003

(54) Toll charging system responsive to traveling length and method for operating the same

(76) Inventor: Yen-Wu Miao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/940,705

(22) Filed: Aug. 29, 2001

(51) Int. Cl. G06F 17/60

(52) U.S. Cl. 705/13; 705/400; 705/1; 705/418

(57) ABSTRACT

A toll charging system responsive to a traveling length and the method for operating the same are disclosed. The system comprises a plurality of control path units, a user mobile communication unit, at least one mobile communication unit, and at least one financial unit. The method comprises the step of identifying a vehicle by a vehicle identification devices in outlet and control path unit. Then a signal emitting device transfers vehicle and location information to a mobile communication base unit. Then, the mobile communication device transfers a message of user's financial account and vehicle information to a mobile communication base unit. The signal emitting device transfers information to the mobile communication base unit. The mobile communication device again transfers a message of user's financial account and vehicle information. Then, a central processing unit calculates a toll responsive to received information; and paying the toll to a financial unit.

### BACKGROUND OF THE INVENTION

1. Field of the invention

The present invention is related to a toll charging system responsive to a traveling length and the method for operating the same, wherein by a plurality of inlet control path units installed at the inlet control paths with the calculation function of the mobile communication unit of the user and the mobile communication base unit, the charging operation can be performed according to the traveling length of the user.

2. Description of the Related Art

Currently, since the highly development of industry and commerce, time and efficiency are important in the commercial competition. In past, the toll is charged manually. A plurality of charging stations are disposed on a way to be charged, such as a super high way. Not only many people are necessary to be employed, but also as a car enters into the station, it must stop for paying the toll. This operation way not only requires a large amount of labor, but also the traffic is affected greatly.

To solve above problem, electronic paying system is developed. In this system, the users are pre-charged for acquiring an IC card. Card readers are installed on the cars. As the car of the user passes through the stations, an infrared signal is emitted to radiate the card reader so as to reduce the accumulated points represented by the IC card.

However, although this kind of toll charging system may reduce the labor in charging and the speed of vehicle passing through the charging station can be increased a little. However, when the charge of the IC card is insufficient, the charging operation can not be made in normal. Then, the user must pay the tolls to a specific place. Furthermore, this system only acquires the data of the user from the card reader, while the data of the vehicle can not be acquired. If a large vehicle uses the IC card and car reader of a smaller vehicle, then the toll is charged based on the small vehicle. Moreover, one may hid the card reader so that no data of the user is acquired, even no toll is paid.

Moreover, a charging system is developed, in that the toll is charged in an unknown condition. In this system, a vehicle identification device installed at the charging station is used. The vehicle identification device serves to identify a communication device on a traffic tool, or identify a vehicle with an electronic packet for charging. In this system, the vehicle identification device is interactive with an electronic packet. If the toll is charged in normal, the vehicle identification device is not used. If it is in an abnormal condition, then the electronic packet is not used. In this charging system, the identifications of vehicles and charging transaction can be performed correctly. However, all the communication and identification of different unit are performed in available time, i.e., a vehicle may be identified, and messages must be interchanged and acknowledged in the charging station. If the speed of the vehicle is too fast, then the vehicle not being charged correctly must be charged in the future time.

The charging system is in general installed at the charge station of a super highway and a vehicle is charged as it passes through the charge station. However, people knows the positions of the station, thus, the driver may go by another way so to avoid to be charged.

Therefore there is an eager demand for a novel design which may resolve the problem encountered in the prior art.

### SUMMARY OF THE INVENTION

Accordingly, the primary object of the present invention is to provide a toll charging system responsive to a traveling length and the method for operating the same, wherein by a plurality of inlet control path units installed at the inlet control paths are utilized with the calculation function of the mobile communication unit of the user and the mobile communication base unit, the charging operation can be performed according to the traveling length of the user.

Another object of the present invention is to provide a toll charging system responsive to a traveling length and the method for operating the same, wherein the control path unit has a vehicle identification device for identifying the type, number, position and time that the vehicle entering to the control path for calculating the toll and as a base for supplementing the toll.

A further object of the present invention is to provide a toll charging system responsive to a traveling length and the method for operating the same, wherein the mobile communication unit is a mobile communication unit for transferring the information comprising the user's financial account for transferring charges.

A further object of the present invention is to provide a toll charging system responsive to a traveling length and the method for operating the same, wherein the mobile communication unit has an actuating device for receiving signals from a control path unit to actuate the mobile communication unit.

A further object of the present invention is to provide a toll charging system responsive to a traveling length and the method for operating the same, wherein a testing is made as a vehicle enter into an inlet control path, while as it leave the control path unit, the toll and traveling length are calculated.

The various objects and advantages of the present invention will be more readily understood from the following detailed description when read in conjunction with the appended drawing.

### BRIEF DESCRIPTION OF THE DRAWINGS

FIG. 1 is a schematic view showing the installation of one preferred embodiment of the present invention.

FIG. 2 is a system block diagram of the embodiment illustrated in FIG. 1.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

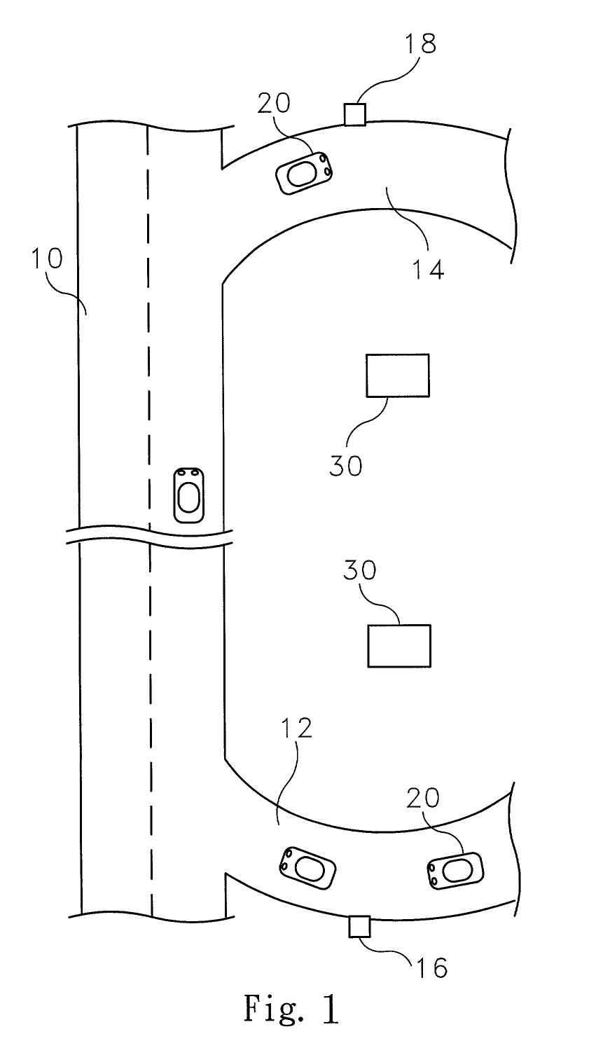

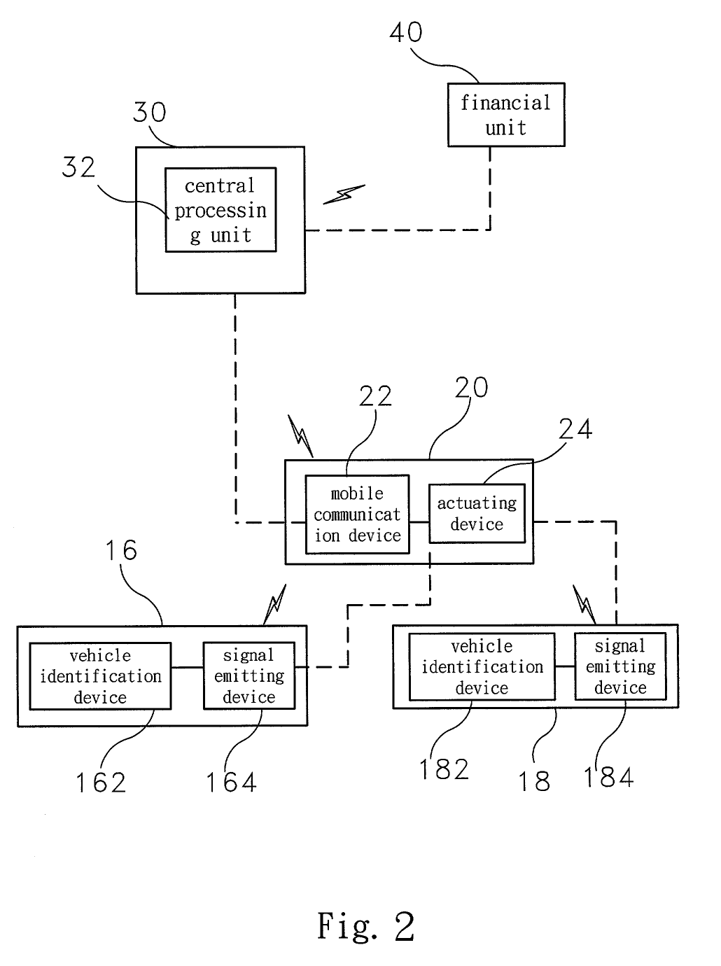

Referring to FIGS. 1 and 2, a schematic view and a system block diagram of the preferred embodiment of the present invention is illustrated. As illustrated in the drawing, the present invention mainly includes a plurality of control path units 16 and 18, a user mobile communication unit 22, at least one mobile communication base unit 32, and at least one financial unit 40. The control path units are installed at different positions for charging, and they can be classified into two classes. One is an inlet control path unit 16 installed at the inlet control path 12, and the other is outlet control path unit 18 installed at the outlet control path 14. Each control path unit includes a vehicle identification devices 162, 182 and a signal emitting device 164, 184. The vehicle 20 of the user is installed with a user mobile communication unit 22. The mobile communication unit 22 includes a mobile communication device 222, for example, current used mobile phones.

When the vehicle 20 of a user enters into the inlet control path 12, the vehicle identification device 162 of the inlet control path unit 16 will actuate to identify the type, number, etc. of the car. Then, the signal emitting device 164 transfers the information of such as the type, number, position and time that the vehicle 20 enters into the control path to the adjacent mobile communication base station 30, for example, base station of a mobile phone provider. Then it is registered to the mobile communication base unit 32. The mobile communication unit 22 of the vehicle 20 transmits a signal with the user's information to the mobile communication base unit 32. Therefore, the mobile communication base unit 32 has the type, number, position and time that the vehicle 20 enters to the control path. Thus, the vehicle 20 may travel in the whole paths successfully until it has arrived to the outlet control path 14.

When the vehicle 20 arrives to the outlet control path 14, the vehicle identification device 182 of the outlet control path unit 18 actuates to identify the type, number, position and time that the vehicle entering to the control path. Then the signal emitting device 184 transfers the messages about the type, number, position and time that the vehicle leaves the control path to the mobile communication base station 30 to be registered to the mobile communication base unit 32 so that the mobile communication device of the mobile communication unit 22 transfers a message with the financial account of the user to the base station. The central processing unit 322 in the mobile communication base unit 32 calculates the traveling length of two registered data. Then, the system charges to the financial unit 40 specified by the account of the user. If the charging transaction is complete correctly, then, the mobile communication device 222 of the user may receive the transaction record from the financial unit 40 and the electronic receipt emitted from the central processing unit 322. If the charging transaction does not complete, then the central processing unit 322 will store the data and the mobile communication device 222 of the user will receive an action emitted from the central processing unit 322 for supplementing the deficit.

Next, the mobile communication unit of the present invention may be further added with an actuating device 224 for interacting with the mobile communication device 222. The operation of this device will be described in the following.

When a vehicle enters into the inlet control path 12, the vehicle identification device 162 of the inlet control path unit 16 will at first identify the type and number of the vehicle. Then the signal emitting device 164 transfers signals about the type, number, position and time that the vehicle enters to the control path. After the actuating device 224 receives the signals, the mobile communication device 222 will be actuated, and then the mobile communication device 222 transfers messages about the type, number, position and time that the vehicle 20 enters to the control path, and the testing data of the user's financial account to the mobile communication base unit 32 of the adjacent mobile communication base station 30 for registering. The central processing unit 322 may make a previous transaction test according to user's financial account. If the test is correct, it will assure that the charging action can be made correctly. If the testing result is incorrect, then the central processing unit 322 emits a signal to inform the user to make a transaction of charging.

When the vehicle 20 is desired to leave from the traffic system to the outlet control path 14, the vehicle identification device 182 of the outlet control path unit 18 will identify the type and number of the vehicle. Then the signal emitting device 184 transfers signals about the type, number, position and time that the vehicle enters to the control path to the mobile communication unit 22 of the vehicle 20. After the actuating device 224 receives the signals, the mobile communication device 222 will be actuated, and then the mobile communication device 222 transfers messages about the type, number, position and time that the vehicle 20 enters to the control path, and the testing data of the user's financial account to the mobile communication base unit 32 of the adjacent mobile communication base station 30 for registering. The central processing unit 322 calculates the traveling length of two registered data and the fee to be paid. Then, the system charges to the financial unit 40 specified by the account of the user.

If the charging transaction is complete correctly, then, the mobile communication device 222 of the user may receive the transaction record from the financial unit 40 and the electronic receipt emitted from the central processing unit 322. If the charging transaction does not complete, then the central processing unit 322 will store the data and the mobile communication device 222 of the user will receive an action emitted from the central processing unit 322 for supplementing the deficit.

If the user does not pay the fee, but to travel in the highway continuously, then the path controlling units 16 and 18 transfers the data about the vehicle to the mobile communication base station 30, and then the central processing unit 322 will inform the police to ban the driver.

Moreover, the vehicle identification devices 162 and 182 may be cameras. After the images from the vehicle 20 are captured, an image identification device (not shown) will process the images. The mobile communication device 222 may be utilized with the current mobile phone. The mobile communication base station 30 may be used directly installed based on the base stations of the mobile phone providers which are commonly installed. The cost of the system can be reduced greatly by current devices. Furthermore, the whole traffic system will operate successfully, and the success rate of automatic charging can be increased. Furthermore, the trouble for supplementing a deficient of charge can be resolved.

In summary, the present invention relates to a charging system of tolls, and especially to a charging system and operating method base on the traveling length. In the present invention, by a plurality of inlet control path units installed at the inlet control paths are utilized with the calculation function of the mobile communication unit of the user and the mobile communication base unit, the charging operation can be performed according to the traveling length of the user.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A toll charging system responsive to a traveling length, comprising:
a plurality of control path units installed at inlets and outlets of a charging traffic system, each unit including a vehicle identification device and a signal emitting device for transferring signals of information about vehicles and locations of the vehicles;
a user mobile communication unit including a mobile communication device for transferring messages comprising user's financial accounts and the vehicles;
at least one mobile communication base unit including a central processing unit for receiving messages of the control path units and the mobile communication unit and checking the messages; and
at least one financial unit for receiving the message from the user and then making a financial transaction for paying a toll;
wherein the central processing unit calculates a traveling length and a toll according to the received location message from an inlet control path and an outlet control path.

2. The charging system as claim in claim 1, wherein the mobile communication device is a mobile phone.

3. The charging system as claim in claim 1, wherein the mobile communication device further includes an actuating device for receiving messages about the control path units for actuating the mobile communication device.

4. The charging system as claim in claim 1, wherein the vehicle identification device is a camera.

5. The charging system as claim in claim 4, wherein the vehicle identification device includes an image identification device.

6. The charging system as claim in claim 5, wherein the mobile communication device includes an actuating device for receiving signals of the control path units and actuating the mobile communication device.

7. The charging system as claim in claim 6, wherein messages from the mobile communication unit includes types, numbers, positions of vehicles entering into and leaving from the control path.

8. The charging system as claim in claim 7, wherein the messages from the mobile communication unit includes time.

9. The charging system as claim in claim 7, wherein the messages from the mobile communication unit includes financial accounts of users.

10. A method utilized in the charging system of claim 1, comprising the steps of:
identifying a vehicle by a vehicle identification device in an inlet control path unit as the vehicle enters into an inlet control path and acquiring information of the vehicle;
a signal emitting device of the inlet control path unit transferring vehicle and location information to a mobile communication base unit;
a mobile communication device in the vehicle transferring a message of user's financial account and vehicle information for registration in a mobile communication base unit;
a vehicle identification device in an outlet control path unit identifying the vehicle when the vehicle leaves from an outlet control path and acquiring information about the vehicle;
a signal emitting device at the control path unit transferring information about the vehicle and locations to the mobile communication base unit;
the mobile communication device in the vehicle again transferring a message of user's financial account and vehicle information for registration in a mobile communication base unit;
a central processing unit in the mobile communication base unit calculating a toll responsive to received information; and paying the toll from the user's financial account to a financial unit.

11. The method as claim in claim 10, wherein the information of the vehicle includes a type and a number of the vehicle.

12. The method utilized in the charging system claim 3, comprising the steps of:
identifying a vehicle by a vehicle identification device in an inlet control path unit as the vehicle enters into an inlet control path and acquiring information of the vehicle;
the signal emitting device of the control path unit transferring vehicle and location information to an actuating device within the vehicle;
the actuating device actuating the mobile communication device in the vehicle for transferring a message of user's financial account and vehicle information for registration in a mobile communication base unit;
the vehicle identification device in an outlet control path unit identifying the vehicle when the vehicle leaves from an outlet control path and acquiring information about the vehicle;
a signal emitting device at the control path unit transferring information about the vehicle and locations to the actuating device in the vehicle;
the actuating device actuating the mobile communication device in the vehicle again for transferring a message of user's financial account and vehicle information for registration in a mobile communication base unit;
a central processing unit in the mobile communication base unit calculating a toll responsive to the received information; and
paying the toll from the user's financial account to a financial unit.

13. The method as claim in claim 12, wherein the information of the vehicle includes a type and a number of the vehicle.

14. The method as claim in claim 12, wherein after a transaction of paying tolls is complete, the central processing unit transfers a message to the mobile communication device.

15. The method as claim in claim 14, wherein the transaction message is an electronic receipt.

16. The method as claim in claim 14, wherein the transfer message is information for supplementing deficit charges.

17. The method as claim in claim 12, wherein after the mobile communication base unit receives messages of the user's financial account and information of the vehicle and location from the mobile communication unit at the inlet control path, then the central processing unit pretests a transaction to a specific financial unit based on the user's financial account.
